(19) United States
(12) Patent Application Publication
(10) Pub. No.: US 2025/0103841 A1
(43) Pub. Date: Mar. 27, 2025

(54) IMAGE READING APPARATUS AND IMAGE FORMING APPARATUS

(71) Applicant: CANON KABUSHIKI KAISHA, Tokyo (JP)

(72) Inventors: HIROMU SHIMIZU, Chiba (JP); AKIRA OTAKE, Ibaraki (JP)

(21) Appl. No.: 18/887,658

(22) Filed: Sep. 17, 2024

(30) Foreign Application Priority Data
Sep. 22, 2023 (JP) 2023-158510

(51) Int. Cl. G06K 15/02; B41J 2/21; H04N 1/00; H04N 1/047

(52) U.S. Cl. CPC G06K 15/1878; B41J 2/2146; G06K 15/027; H04N 1/00801; H04N 1/0473; G06K 2215/101; H04N 2201/0081

(57) ABSTRACT

An image reading apparatus includes a reading unit for reading an image formed on a sheet, a reference member for performing shading correction, and a moving mechanism including a drive source, a cam to be rotated by the drive source, and a moving member that abuts against the cam, wherein, with a conveying direction of the sheet being a first direction, a width direction of the sheet intersecting the first direction being a second direction, and a direction intersecting the first direction and the second direction being a third direction, the moving mechanism is configured to be operable to move the reading unit to a first position and a second position that is different from the first position in position in the third direction.

### BACKGROUND OF THE INVENTION

### Field of the Invention

The present disclosure relates to an image reading apparatus for reading an image formed on a sheet and an image forming apparatus including such an image reading apparatus.

### Description of the Related Art

A market for printing machines is expanding in a commercial printing field and an industrial printing field. Printing methods used by printing machines in such fields include an electrophotographic method, which is spreading also into an offset printing market, and an inkjet method, which has successfully developed a wide-range market with its large format, low initial cost, and ultra-high speed, for example.

Examples of an inkjet printing machine include a line head type recording apparatus. In the line head type recording apparatus, a recording head fixed to a main body ejects liquid droplets in conjunction with a sheet being conveyed, to thereby print an image on the sheet. When the line head type recording apparatus is used in the commercial printing field and the industrial printing field in each of which image quality is required, an image reading apparatus is provided on a downstream side of the recording head in a conveying direction of the sheet. The image reading apparatus reads the image formed on the sheet. A reading result obtained by the image reading apparatus is used to detect a defect of ejection of liquid droplets by the recording head. In addition, the reading result obtained by the image reading apparatus is used to adjust color misregistration, image density unevenness, and geometric characteristics of the image to be printed. Here, the geometric characteristics of the image refer to a shape, a position, and the like of the image.

The image reading apparatus irradiates the sheet with light from a light source, and receives light reflected by the sheet through use of a line sensor, to thereby read the sheet. The image reading apparatus performs shading correction at the time of reading the sheet. The shading correction is performed in order to correct variation in the light amount distribution of light emitted onto the sheet and variation in the sensitivity of the line sensor for receiving the reflected light. When the shading correction is performed, a white reference plate, which is a white reference member, is read. The white reference plate is preferred to be located at the same position as a position of the sheet being read. In particular, the white reference plate is preferred to be spaced apart from the light source or line sensor by the same distance as a distance between the sheet being read and the light source or line sensor in order to perform the shading correction with high accuracy.

In Japanese Patent Application Laid-open No. 2011-130288, there is disclosed an image reading apparatus that generates an initial value of correction data for the shading correction from read data of a white reference plate attached to the image reading apparatus and read data obtained by reading a separate white reference plate different from the attached white reference plate under a state in which the separate white reference plate is placed at a reading position of an original. The initial value of the correction data is stored in the image reading apparatus to be used at the time of the shading correction.

### SUMMARY OF THE INVENTION

An image reading apparatus according to one embodiment of the present disclosure includes a reading unit for reading an image formed on a sheet, a reference member for performing shading correction, and a moving mechanism including a drive source, a cam to be rotated by the drive source, and a moving member that abuts against the cam, wherein, with a conveying direction of the sheet being a first direction, a width direction of the sheet intersecting the first direction being a second direction, and a direction intersecting the first direction and the second direction being a third direction, the moving mechanism is configured to be operable to move the reading unit to a first position and a second position that is different from the first position in position in the third direction, and wherein the moving mechanism is configured to be moved by rotation of the cam, and the reading unit is moved by movement of the moving mechanism, wherein the moving mechanism is configured to move the reading unit to the first position at a time of reading the sheet, and move the reading unit to the second position at a time of performing the shading correction, and wherein the moving mechanism is configured to adjust a first distance in the third direction from the reading unit to the sheet and a second distance in the third direction from the reading unit to the reference member by moving the reading unit to the first position and the second position.

An image forming apparatus according to another embodiment of the present disclosure includes an image forming unit configured to form an image on a sheet, a reading unit for reading the image formed on the sheet by the image forming unit, a reference member for performing shading correction, and a moving mechanism including a drive source, a cam to be rotated by the drive source, and a moving member that abuts against the cam, wherein, with a conveying direction of the sheet being a first direction, a width direction of the sheet intersecting the first direction being a second direction, and a direction intersecting the first direction and the second direction being a third direction, the moving mechanism is configured to be operable to move the reading unit to a first position and a second position that is different from the first position in position in the third direction, and wherein the moving mechanism is configured to be moved by rotation of the cam, and the reading unit is moved by movement of the moving mechanism, wherein the moving mechanism is configured to move the reading unit to the first position at a time of reading the sheet, and move the reading unit to the second position at a time of performing the shading correction, and wherein the moving mechanism is configured to adjust a first distance in the third direction from the reading unit to the sheet and a second distance in the third direction from the reading unit to the reference member by moving the reading unit to the first position and the second position.

Further features of the present invention will become apparent from the following description of exemplary embodiments (with reference to the attached drawings).

### BRIEF DESCRIPTION OF THE DRAWINGS

FIG. 1 is a configuration view of an image forming system.

FIG. 2 is a configuration explanatory view of a print module.

FIG. 3A, FIG. 3B, FIG. 3C, and FIG. 3D are configuration explanatory views of an image reading apparatus.

FIG. 4 is a cross-sectional view of the image reading apparatus.

FIG. 5 is an explanatory diagram of a control board.

FIG. 6A and FIG. 6B are explanatory views of a moving mechanism of a reading unit.

FIG. 7A and FIG. 7B are explanatory views of the moving mechanism of the reading unit.

FIG. 8A and FIG. 8B are explanatory views of the moving mechanism of the reading unit.

FIG. 9A and FIG. 9B are explanatory views of the moving mechanism of the reading unit.

FIG. 10A and FIG. 10B are explanatory views of the moving mechanism of the reading unit.

FIG. 11 is a flow chart for illustrating reading processing for a sheet.

### DESCRIPTION OF THE EMBODIMENTS

Now, referring to the accompanying drawings, description is given of at least one exemplary embodiment of the present disclosure.

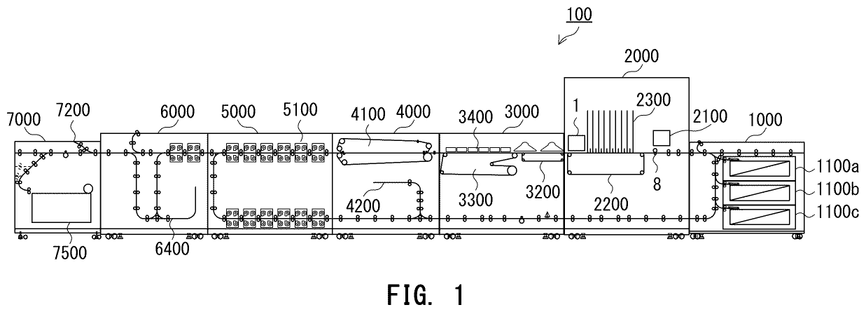

FIG. 1 is a configuration view of an image forming system in the at least one embodiment. An image forming system 100 is, for example, a printing machine to be used in a commercial and industrial printing field. The image forming system 100 in the at least one embodiment is a sheet-fed inkjet recording apparatus which generates a printed product by forming an ink image on a sheet with use of two liquids which are a reaction liquid and ink. The image forming system 100 includes a sheet feeding module 1000, a print module 2000, a drying module 3000, a fixing module 4000, a cooling module 5000, a reversing module 6000, and a delivery stacking module 7000. A cut sheet (hereinafter simply referred to as “sheet”) on which an image is to be printed is fed from the sheet feeding module 1000, receives predetermined processing at each module, and is delivered as a printed product from the delivery stacking module 7000.

The sheet feeding module 1000 includes a plurality of (in the at least one embodiment, three tiers of) sheet storage portions 1100a to 1100c. The sheet storage portions 1100a to 1100c can each store sheets. The sheet storage portions 1100a to 1100c are configured so that each sheet storage portion can be pulled out to a front side of the apparatus. The sheet storage portions 1100a to 1100c are pulled out to the front side of the apparatus to receive sheets. The sheet feeding module 1000 feeds sheets one by one to the print module 2000. Accordingly, the sheet storage portions 1100a to 1100c are each provided with a separation belt and a conveying roller. The number of the sheet storage portions 1100a to 1100c is an example, and a single tier of sheet storage portion, or two, or four or more, tiers of sheet storage portions may be provided.

The print module 2000 is an inkjet image forming apparatus, and forms an image on the sheet fed from the sheet feeding module 1000. The print module 2000 includes a pre-image-forming registration correction portion 2100, a print belt unit 2200, and a recording portion 2300. The pre-image-forming registration correction portion 2100 corrects a tilt and a position of the sheet fed from the sheet feeding module 1000, and conveys the corrected sheet to the print belt unit 2200.

The print belt unit 2200 and the recording portion 2300 are arranged so as to face each other across a conveying path of the sheet, on a downstream side of the pre-image-forming registration correction portion 2100 in a conveying direction of the sheet. The print belt unit 2200 conveys, by suction, the sheet conveyed from the pre-image-forming registration correction portion 2100. The recording portion 2300 is an image forming portion for forming an image on the sheet conveyed from the print belt unit 2200 by performing, from above the sheet, recording processing (printing) with a recording head. The recording head executes printing by ejecting ink onto the sheet. A clearance between the recording head and the sheet is kept constant through conveyance of the sheet by way of suction by the print belt unit 2200.

A plurality of recording heads are arranged side by side along the conveying direction of the sheet. The recording portion 2300 in the at least one embodiment includes eight line-type recording heads corresponding to four colors of yellow (Y), magenta (M), cyan (C), and black (K) as well as a reaction liquid and three spot colors. The number of colors and the number of recording heads are not limited to eight. Examples of an adoptable inkjet method include a method that uses a heating element, a method that uses a piezo element, a method that uses an electrostatic element, and a method that uses a MEMS element. Ink of each color is supplied to the corresponding recording head via an ink tube from an ink tank (not shown).

The sheet on which printing has been executed by the recording portion 2300 is conveyed by the print belt unit 2200. An image reading apparatus 1 which is an in-line scanner is placed on a downstream side of the recording portion 2300 in the conveying direction. The image reading apparatus 1 is used to correct a printed image by detecting misalignment and color densities of the image formed on the sheet. Specifically, a reading result of the sheet obtained by the image reading apparatus 1 is used to calculate coordinates of a mark formed on an edge of the sheet and coordinates of the four corners of the sheet (detection of geometric characteristics). The coordinates of the mark and the coordinates of the four corners of the sheet are used to adjust the right angles and skew of the image, leading-edge registration and left registration, a main magnification and a sub-magnification, and the like, to thereby correct image misalignment. In addition, pixel values (brightness values) are analyzed from the reading result of a dedicated chart obtained by the image reading apparatus 1, and are used to adjust an ejection amount of each recording head (detection of an image density). Through adjustment of the ejection amount of the recording head, each color density is corrected.

The drying module 3000 dries the sheet on which the image has been formed by the print module 2000. The drying module 3000 reduces a liquid constituent contained in the ink by drying the sheet, to thereby improve fixability of the ink to the sheet. The drying module 3000 includes a decoupling portion 3200, a drying belt unit 3300, and a hot air blowing portion 3400.

The sheet on which printing has been executed by the recording portion 2300 of the print module 2000 is conveyed to the decoupling portion 3200 inside the drying module 3000. The decoupling portion 3200 conveys the sheet by lightly holding the sheet with use of a wind pressure from above and friction from a belt. This prevents misalignment of a part of the sheet that remains on the print belt unit 2200 in a case where the sheet lays partially on the decoupling portion 3200 and the rest of the sheet is on the print belt unit 2200.

The sheet conveyed from the decoupling portion 3200 is conveyed by suction by the drying belt unit 3300, and hot air is concurrently blown onto the sheet from the hot air blowing portion 3400 placed above the belt, to thereby dry an ink applied surface (image printed surface). As the drying method, the method of blowing hot air may be combined with a method of irradiating a sheet surface with an electromagnetic wave (an ultraviolet ray, an infrared ray, or the like), or a conductive heat transfer method by contact with a heat generator.

The fixing module 4000 fixes the image to the sheet by heating the sheet that has been dried by the drying module 3000, and thus drying the ink. The fixing module 4000 includes a fixing belt unit 4100 which includes an upper belt unit and a lower belt unit. The fixing module 4000 passes the sheet that has been conveyed from the drying module 3000 between the upper belt unit and the lower belt unit which have each been heated, to thereby fix the ink to the sheet.

The cooling module 5000 cools the sheet to which the image has been fixed by the fixing module 4000, to thereby solidify the ink softened from heating, and, at the same time, suppress a temperature change caused in the sheet by a downstream apparatus. The cooling module 5000 includes a plurality of cooling portions 5100. The plurality of cooling portions 5100 cool the high-temperature sheet conveyed from the fixing module 4000. Each cooling unit 5100 includes a cooling box, a fan, and a nozzle formed in a conveying guide. The fan takes outside air into the cooling box, to thereby raise a pressure in the cooling box. The air thus taken into the cooling box is blown onto the sheet by the nozzle. Through blowing of the air onto the sheet in this manner, the sheet is cooled. The plurality of cooling portions 5100 are arranged on each side of the conveying path so that the sheet can be cooled from both sides.

A conveying path switching portion is provided in the cooling module 5000. The conveying path switching portion switches the conveying path of the sheet between a path on which the sheet is to be conveyed to the reversing module 6000 and a duplex-printing conveying path to be used in duplex printing.

In duplex printing, the sheet is conveyed along the conveying path in a lower part of the cooling module 5000 to be conveyed along the duplex-printing conveying path of the fixing module 4000, the drying module 3000, the print module 2000, and the sheet feeding module 1000. A duplex-printing portion of the fixing module 4000 is provided with a first reversing portion 4200 for reversing a front surface and a back surface of the sheet. The sheet is conveyed to the first reversing portion 4200 once, and then reversed and conveyed to the drying module 3000 side, and the image printing surface is thus reversed. This enables printing on the back surface of the sheet. After that, the sheet is again conveyed to the pre-image-forming registration correction portion 2100, the print belt unit 2200, and the recording portion 2300 of the print module 2000 to be printed on.

The reversing module 6000 includes a second reversing portion 6400. The reversing module 6000 can use the second reversing portion 6400 to reverse the front surface and the back surface of the sheet being conveyed. Directions in which the front surface and the back surface of the sheet that is about to be delivered can thus be changed. The delivery stacking module 7000 includes a top tray 7200 and a stacking portion 7500. The delivery stacking module 7000 stacks, in an orderly manner, sheets conveyed from the reversing module 6000.

### Print Module

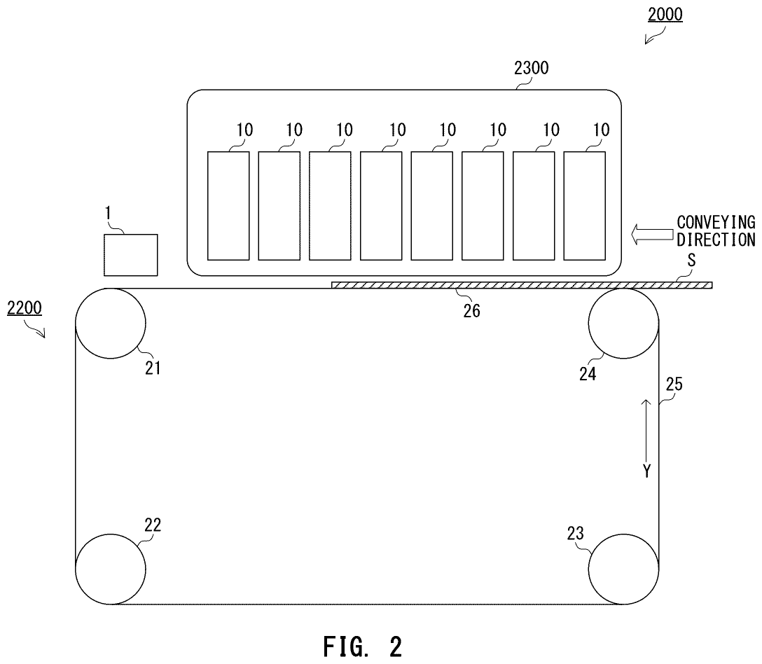

FIG. 2 is a configuration explanatory view of the print module 2000. The print module 2000 includes a plurality of recording heads 10 which form the recording portion 2300, the print belt unit 2200 that conveys the sheet S, and the image reading apparatus 1. The recording heads 10 form an image on the sheet S by jetting ink from above with respect to the sheet S that has been fed one by one from the sheet feeding module 1000 and has passed through the pre-image-forming registration correcting portion 2100.

When the image is formed, the sheet S is attracted through suction by the print belt unit 2200 and conveyed in the conveying direction. The attraction through suction by the print belt unit 2200 stabilizes the conveyance behavior of the sheet S so that a distance with respect to the recording heads 10 at the time of image formation is kept constant. The print belt unit 2200 includes a plurality of (four in the at least one embodiment) stretch rollers 21 to 24 and a print belt 25 stretched by the stretch rollers 21 to 24. The sheet S is attracted through suction onto a belt surface of the print belt 25 stretched by the stretch roller 21 and the stretch roller 24. The image formation is performed on the belt surface. Thus, in the at least one embodiment, the belt surface extending between the stretch roller 21 and the stretch roller 24 is referred to as an image formation surface 26.

The print belt 25 has a large number of suction holes for suction with respect to the sheet S, and rotates in a Y direction indicated by the arrow. In a space surrounded by the print belt 25, a vacuum (not shown) is provided for suction. The print belt 25 attracts the sheet S onto the image formation surface 26 with a suction force generated by the vacuum and rotates to convey the sucked sheet S in the conveying direction. The sheet S attracted onto the image formation surface 26 is conveyed under a state in which a certain clearance is secured between the sheet S and the recording heads 10. The print belt 25 functions as a conveyance portion that carries and conveys the sheet S. In the recording portion 2300, the plurality of recording heads 10 are arranged side by side along the conveying direction of the sheet S. As described above, the recording portion 2300 in the at least one embodiment has eight line-type recording heads 10 corresponding to four colors of black, yellow, magenta, and cyan as well as a reaction liquid and three spot colors.

The image reading apparatus 1 is arranged along the image formation surface 26 on the downstream side of the recording heads 10 in the conveying direction of the sheet S, and reads a test image formed on the sheet S being conveyed by the print belt unit 2200. The test image is, for example, an image for detecting the geometric characteristics of the image on the sheet S or the image density of the image on the sheet S. The geometric characteristics or image density of the image is detected based on the reading result (read image) of the sheet S obtained by the image reading apparatus 1. In a case of correcting the geometric characteristics, correction values for the geometric characteristics are generated based on differences between the geometric characteristics obtained from the read image and nominal geometric characteristics. A print position of the image given at the time of image formation is adjusted through use of the correction values. In a case of correcting the image density, a correction value for the image density is generated based on a difference between an actual image density obtained from the read image and an ideal image density. The image density exhibited at the time of image formation is adjusted with the correction value (the ejection amount of liquid droplets ejected from the recording heads 10 is adjusted).

### Image Reading Apparatus

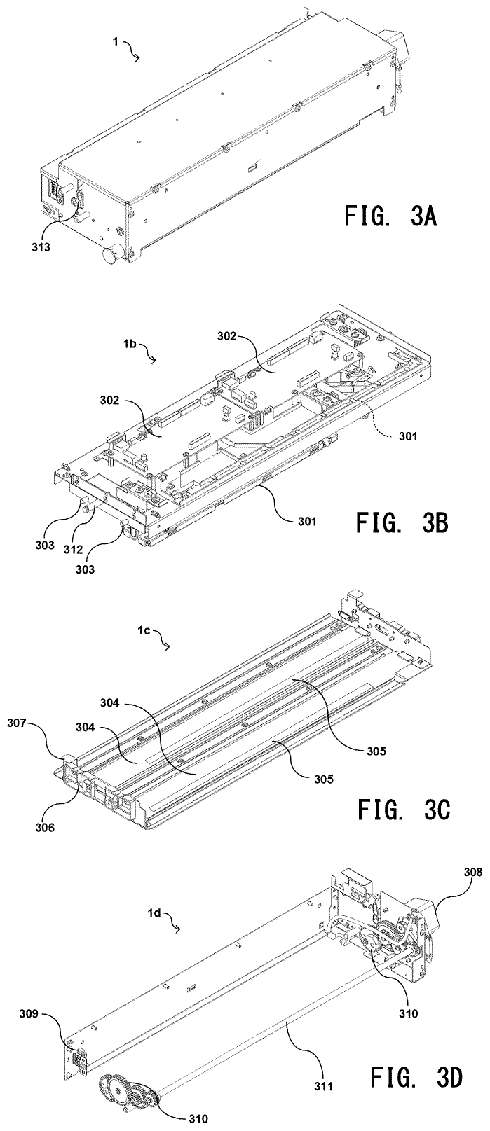

FIG. 3A to FIG. 3D are configuration explanatory views of the image reading apparatus 1. The image reading apparatus 1 is configured by combining an inner box 1b, a glass moving portion 1c, an outer box 1d, and the like. FIG. 3A is an external perspective view of a casing of the image reading apparatus 1. FIG. 3B is a perspective view of the inner box 1b. FIG. 3C is a perspective view of the glass moving portion 1c. FIG. 3D is a perspective view of the outer box 1d.

As illustrated in FIG. 3B, a reading unit 301 for reading an image is attached to the inner box 1b. In FIG. 3B, although hidden on a back side of the inner box 1b, two reading units 301 are arranged side by side in a direction intersecting the conveying direction of the sheet S. By arranging the two reading units 301 in this manner, it is possible to read the sheet S having a large width (length in a width direction intersecting the conveying direction of the sheet S). Two control boards 302 are provided in correspondence with the two reading units 301. Each of the control boards 302 is a controller that controls operation of the corresponding reading unit 301.

The inner box 1b is provided with two inner box short shafts 303 and an inner box long shaft 312. At the time of shading correction, the inner box 1b moves in upward and downward directions due to the two inner box short shafts 303. The upward direction is a direction away from the image formation surface 26, and the downward direction is a direction toward the image formation surface 26. The inner box long shaft 312 restricts movements of the inner box 1b in leftward and rightward directions. The leftward direction is the conveying direction of the sheet S, and the rightward direction is a direction opposite to the conveying direction of the sheet S. The inner box long shaft 312 is configured to allow the inner box 1b to move in the upward and downward directions but restrict the movement thereof in the leftward and rightward directions by fitting with an inner box movement restricting member 313 of the casing (see FIG. 3A).

As illustrated in FIG. 3C, the glass moving portion 1c is provided with two reading glasses 304 corresponding to the two reading units 301, a flag 307, and a glass moving member 306 that receives the inner box short shafts 303. A white reference plate 305 that is a reference member for performing the shading correction is attached to each of the two reading glasses 304. The two reading glasses 304 are attached to the glass moving member 306. At the time of the shading correction, the entire glass moving portion 1c including the white reference plate 305 moves in the leftward direction (short shaft direction of the glass moving portion 1c; conveying direction of the sheet S).

In FIG. 3D, the casing of the outer box 1d illustrated in FIG. 3A is omitted. The outer box 1d is provided with a motor 308, a photosensor 309, two cams 310 on the front side and the back side of the figure, and a shaft 311. The glass moving member 306 abuts against peripheral surfaces of the two cams 310. For that reason, in a case where the motor 308 is driven to rotate the two cams 310, the glass moving member 306 moves by being pushed by the cams 310. A drive force of the motor 308 is transmitted to the cam 310 on the front side by the shaft 311. The photosensor 309 detects the position of the glass moving portion 1c in a case where a light-transmitting state and a light-blocking state are switched by the flag 307 provided to the glass moving portion 1c.

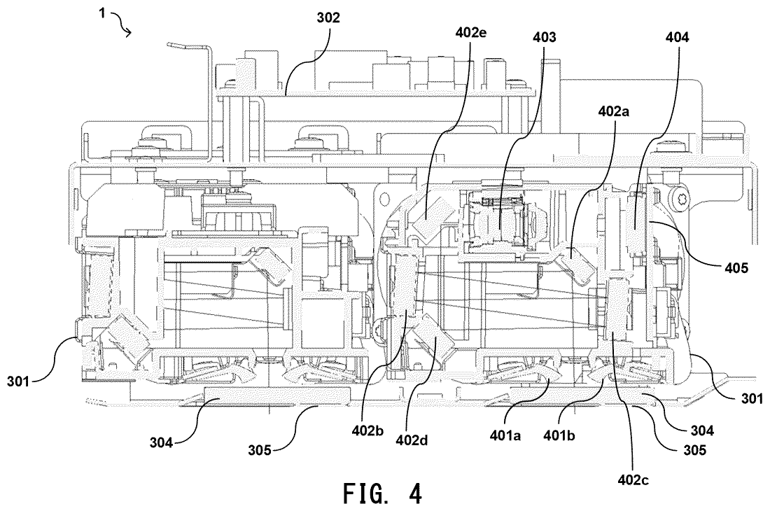

FIG. 4 is a cross-sectional view of the image reading apparatus 1. This cross-sectional view is an illustration of a cross section of the image reading apparatus 1 cut in the conveying direction of the sheet S. The reading unit 301 includes light sources 401a and 401b, reflecting mirrors 402a, 402b, 402c, 402d, and 402e, an imaging lens 403, a light-receiving portion 404, and a sensor substrate 405. The light sources 401a and 401b irradiate the sheet S on the image formation surface 26 with light. The light sources 401a and 401b are configured by arranging a plurality of light-emitting elements, for example, light emitting diodes (LEDs), in a line in a predetermined direction. The light-receiving portion 404 receives light reflected by the sheet S of the light emitted from the light sources 401a and 401b. The reflecting mirrors 402a to 402e form an optical system that guides the light reflected by the sheet S to the imaging lens 403. The imaging lens 403 causes an image of the reflected light guided by the reflecting mirrors 402a to 402e to be formed on the light-receiving surface of the light-receiving portion 404.

The light-receiving portion 404 outputs a reading result (read image) that is an electrical signal corresponding to the reflected light received on the light-receiving surface. This reading result is an analog signal representing the image read from the sheet S. The light-receiving portion 404 is configured by arranging a plurality of photoelectric conversion elements, for example, charge coupled device (CCD) sensors, in the same direction as that of the line of light-emitting elements. The light-receiving portion 404 is mounted on the sensor substrate 405. The sensor substrate 405 is connected to the control board 302. The sensor substrate 405 transmits the reading result (read image), which is the analog signal output from the light-receiving portion 404, to the control board 302. A configuration of the control board 302 is described later.

The reading unit 301 reads an image with a main scanning direction being set to the direction in which each of the line of the light-emitting elements of the light sources 401a and 401b and the line of the photoelectric conversion elements of the light-receiving portion 404 extends. The main scanning direction is, for example, the direction intersecting the conveying direction of the sheet S. With a sub-scanning direction being set to the conveying direction of the print belt 25 intersecting the main scanning direction, the reading unit 301 reads an image on the sheet S being conveyed along the conveying direction.

The white reference plate 305 provided on the reading glass 304 is read by the reading unit 301 at the time of the shading correction. The light-receiving portion 404 has manufacturing variation for each photoelectric conversion element (each pixel). In addition, it is not easy to cause irradiation light emitted from the light sources 401a and 401b to become uniform in the main scanning direction. For those reasons, even when the sheet S on which an image having a uniform image density is formed is used to read the image therefrom, there is a possibility that digital values of image data, which is the reading result, may vary for each position in the main scanning direction.

In order to suppress such variation, the shading correction is performed. Specifically, the reading unit 301 reads the white reference plate 305. From the reading result of the white reference plate 305, such a correction value as to cause the reading result (e.g., brightness values) of the respective pixels in the main scanning direction to become uniform at a specific value is derived. This correction value is used to correct the irradiation amount of the light sources 401a and 401b, sensitivity variation of the photoelectric conversion elements of the light-receiving portion 404, or the reading result of the image on the sheet S, thereby correcting the manufacturing variation and the variation in the light amount.

It is preferred that a distance from the reading unit 301 to the white reference plate 305 exhibited at the time of reading the white reference plate 305 be the same as a distance from the reading unit 301 to the sheet S exhibited at the time of reading the sheet S. Such a distance from the reading unit 301 to an object to be read (the white reference plate 305 or the sheet S) is hereinafter referred to as “reading distance.” The variation in the light distribution of the light sources 401a and 401b differs depending on the reading distance, and hence in a case where the reading distance differs between the time of the shading correction and the time of reading the sheet S, there is a fear that appropriate shading correction may fail to be performed, resulting in deterioration in image quality. In the at least one embodiment, the reading distance is a distance in a direction intersecting the main scanning direction and the sub-scanning direction.

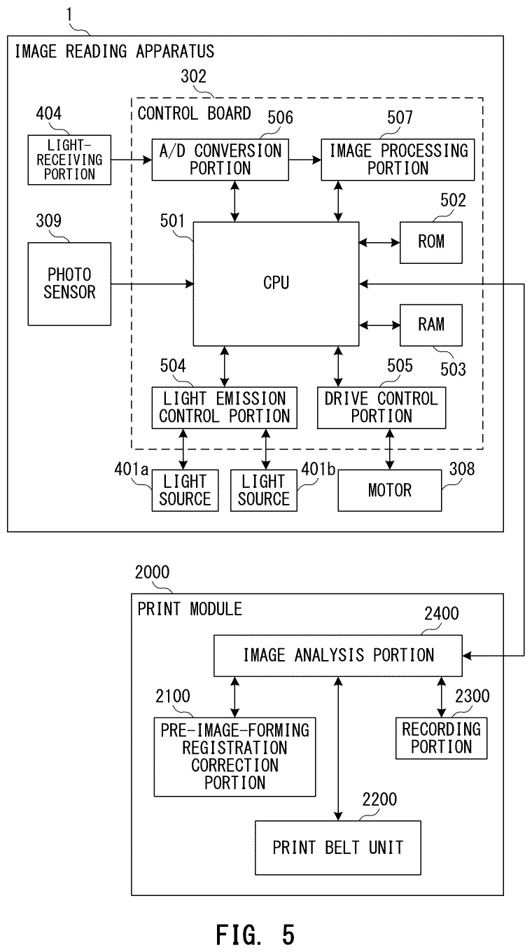

FIG. 5 is an explanatory diagram of the control board 302. The control board 302 is electrically connected to the light sources 401a and 401b and the light-receiving portion 404 of the reading unit 301. The control board 302 is further electrically connected to the motor 308 and the photosensor 309. As described above, the motor 308 is a drive source for moving the glass moving portion 1c on which the white reference plate 305 is provided. In FIG. 5, the image reading apparatus 1 is connected to the print module 2000.

The control board 302 is an information processing device including a central processing unit (CPU) 501, a read only memory (ROM) 502, and a random access memory (RAM) 503. The CPU 501 executes a computer program stored in the ROM 502 with the RAM 503 being used as a work area, to thereby control operation of the image reading apparatus 1. In addition, the control board 302 includes a light emission control portion 504 for controlling operation of the light sources 401a and 401b, a drive control portion 505 for controlling operation of the motor 308, an A/D conversion portion 506 for processing the reading result (read image), and an image processing portion 507. The light emission control portion 504, the drive control portion 505, the A/D conversion portion 506, and the image processing portion 507 are connected to the CPU 501. The control board 302 may be implemented by a discrete product or a one-chip semiconductor product. Examples of the one-chip semiconductor product include a micro-processing unit (MPU), an application specific integrated circuit (ASIC), and a system-on-a-chip (SOC).

The light emission control portion 504 is controlled by the CPU 501 to control operation for turning on and off the light sources 401a and 401b. The drive control portion 505 is controlled by the CPU 501 to transmit a drive signal to the motor 308, to thereby control operation for moving the glass moving portion 1c on which the white reference plate 305 is provided.

The A/D conversion portion 506 is controlled by the CPU 501 to convert the reading result (read image), which is the analog signal output from the light-receiving portion 404, into a digital signal and transmit the digital signal to the image processing portion 507. The image processing portion 507 is controlled by the CPU 501 to perform various types of image processing on the reading result (read image), which is the digital signal acquired from the A/D conversion portion 506, and generate image data representing the image read from the sheet S. The image data is transmitted from the control board 302 to the print module 2000, a personal computer, or the like.

The print module 2000 includes an image analysis portion 2400, the pre-image-forming registration correction portion 2100, the print belt unit 2200, and the recording portion 2300. The image analysis portion 2400 analyzes the image data acquired from the control board 302 to calculate various correction values. The correction values calculated by the image analysis portion 2400 are fed back to the pre-image-forming registration correction portion 2100, the print belt unit 2200, and the recording portion 2300 to be used to adjust geometric characteristics and image density unevenness.

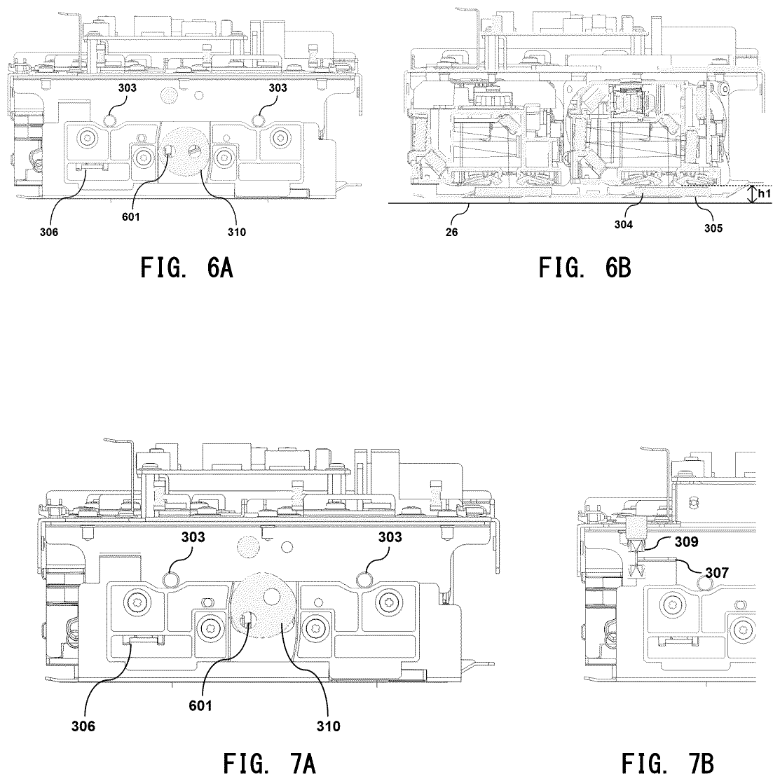

Referring to FIG. 6A to FIG. 10B, a moving mechanism of the reading unit 301 in conjunction with the movement of the position of the white reference plate 305 at the time of the shading correction is described.

FIG. 6A and FIG. 6B are cross-sectional views of the image reading apparatus 1 exhibited in a case where the cam 310 is at a first angle (e.g., 0 degrees). FIG. 6A is a cross-sectional view in the sub-scanning direction at a location of the cam 310. FIG. 6B is a cross-sectional view in the sub-scanning direction at a location of the reading unit 301. In this case, the reading unit 301 reads the sheet S being conveyed along the image formation surface 26.

When the cam 310 is at the first angle, the cam 310 pushes the glass moving portion 1c to the right side (upstream side in the conveying direction of the sheet S) of FIG. 6A relative to a rotation axis 601 of the cam 310. In this case, the inner box short shafts 303 are positioned in recesses in an upper side of the glass moving member 306. Therefore, the reading unit 301 has been moved (lowered) toward the image formation surface 26 side. Having been moved toward the image formation surface 26 side, the reading unit 301 has a reading distance (h1) matching the sheet S being conveyed along the image formation surface 26.

FIG. 7A and FIG. 7B are cross-sectional views of the image reading apparatus 1 exhibited in a case where the cam 310 is at a second angle (e.g., 45 degrees). FIG. 7A is a cross-sectional view in the sub-scanning direction at a location of the cam 310. FIG. 7B is a cross-sectional view in the sub-scanning direction at a location of the flag 307 and the photosensor 309. In this state, the state of the photosensor 309 is changed from the light-transmitting state to the light-blocking state by the flag 307. This allows the control board 302 to grasp the position of the glass moving portion 1c. The control board 302 can move the glass moving portion 1c to a desired position by inputting a signal of a predetermined number of pulses to the motor 308 from this position.

That is, in a case where the state of the photosensor 309 changes from the light-transmitting state to the light-blocking state, the control board 302 determines that the white reference plate 305 has started to move to a reading position of the reading unit 301. By being triggered in a case where the state of the photosensor 309 changes from the light-transmitting state to the light-blocking state, the control board 302 moves the glass moving portion 1c from that position by a predetermined amount, to thereby move the white reference plate 305 to the reading position of the reading unit 301.

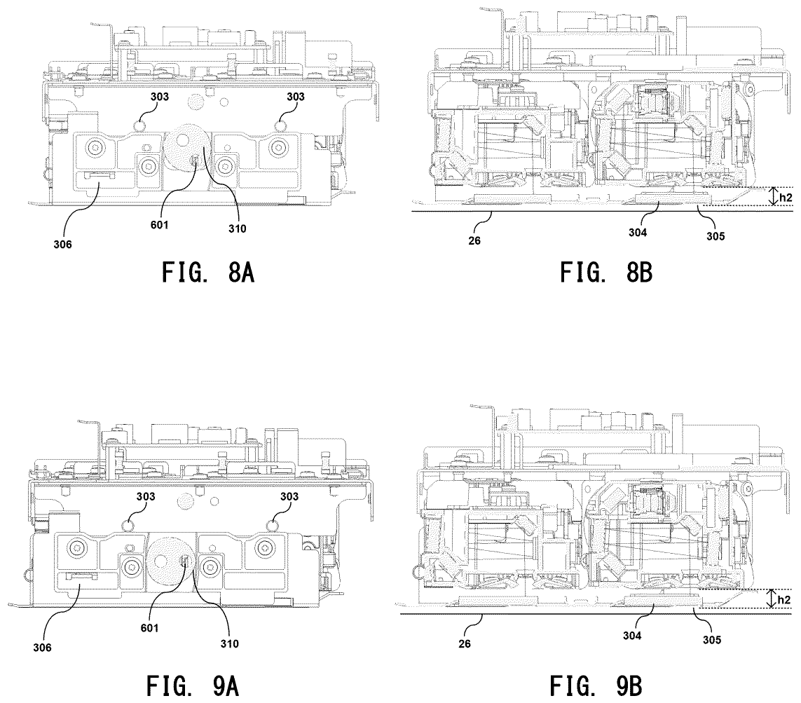

FIG. 8A and FIG. 8B are cross-sectional views of the image reading apparatus 1 exhibited in a case where the cam 310 is at a third angle (e.g., 123 degrees). FIG. 8A is a cross-sectional view in the sub-scanning direction at a location of the cam 310. FIG. 8B is a cross-sectional view in the sub-scanning direction at a location of the reading unit 301. In this case, the reading unit 301 reads the white reference plate 305 in order to perform the shading correction (first sampling).

When the cam 310 is at the third angle, the cam 310 pushes the glass moving portion 1c to the left side (downstream side in the conveying direction of the sheet S) of FIG. 8A relative to the rotation axis 601. In this case, the inner box short shafts 303 have ridden up onto the upper side of the glass moving member 306. Therefore, the reading unit 301 has been moved (raised) in a direction opposite to the direction toward the image formation surface 26. Having been moved in the direction opposite to the direction toward the image formation surface 26, the reading unit 301 has a reading distance (h2) matching the white reference plate 305.

That is, in conjunction with the movement of the glass moving portion 1c by the cam 310, the inner box short shafts 303 fall into the recesses in the upper side of the glass moving member 306 or ride up onto the upper side, thereby changing the reading distance of the reading unit 301. Thus, the reading distance (h1) exhibited at the time of reading the sheet S and the reading distance (h2) exhibited at the time of the shading correction can be made the same. Due to the same reading distance, the shading correction is performed appropriately, and the deterioration in the image quality can thus be suppressed.

FIG. 9A and FIG. 9B are cross-sectional views of the image reading apparatus 1 exhibited in a case where the cam 310 is at a fourth angle (e.g., 180 degrees). FIG. 9A is a cross-sectional view in the sub-scanning direction at a location of the cam 310. FIG. 9B is a cross-sectional view in the sub-scanning direction at a location of the reading unit 301. In this case, the reading unit 301 reads the white reference plate 305 in order to perform the shading correction (second sampling).

When the cam 310 is at the fourth angle, the cam 310 pushes the glass moving portion 1c to the left side (downstream side in the conveying direction of the sheet S) of FIG. 9A relative to the rotation axis 601. In this case, the inner box short shafts 303 have ridden up onto the upper side of the glass moving member 306 with no change from the state of FIG. 8A. Therefore, the reading unit 301 has been moved (raised) in a direction opposite to the direction toward the image formation surface 26. Having been moved in the direction opposite to the direction toward the image formation surface 26, the reading unit 301 has a reading distance (h2) matching the white reference plate 305.

In comparison between FIG. 8B and FIG. 9B, the reading distance (h2) is the same, but the position of the white reference plate 305 is different in the conveying direction of the sheet S. The position of the white reference plate 305 of FIG. 9B is further downstream in the conveying direction of the sheet S than the position of the white reference plate 305 of FIG. 8B. For that reason, positions on the white reference plate 305 that differ from each other in the conveying direction of the sheet S are read by the reading unit 301 in the first sampling and the second sampling. Therefore, it is possible to reduce influence of dust at the time of the shading correction. This technology is well known, and hence description thereof is omitted.

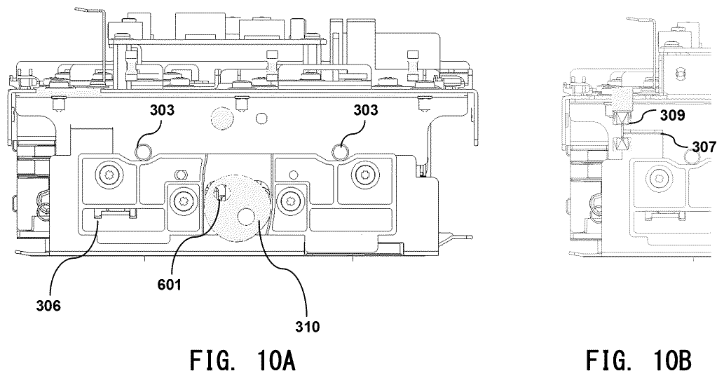

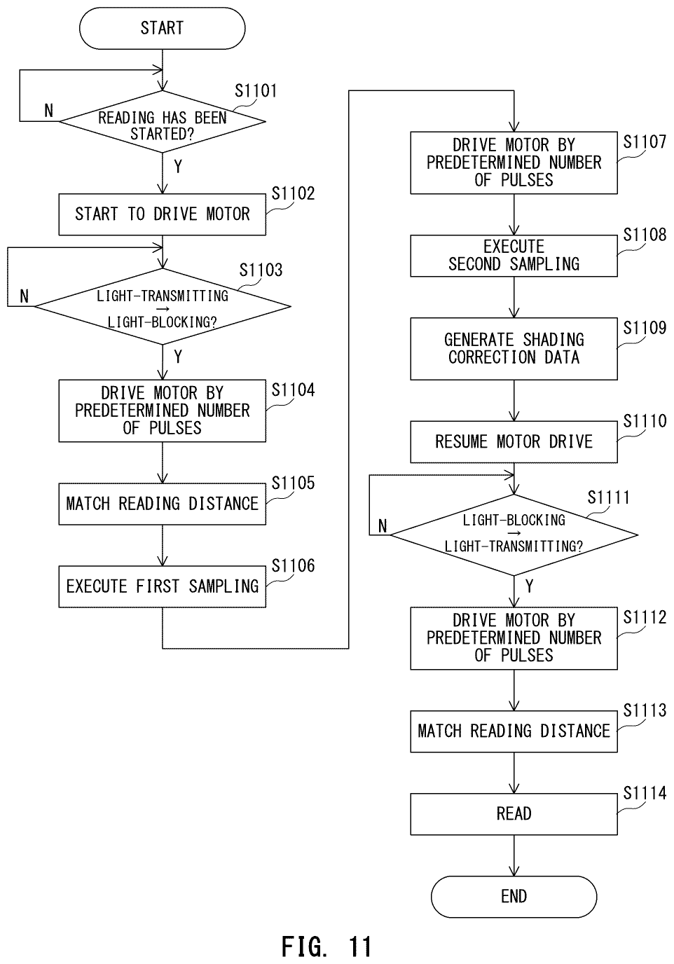

FIG. 10A and FIG. 10B are cross-sectional views of the image reading apparatus 1 exhibited in a case where the cam 310 is at a fifth angle (e.g., 315 degrees). FIG. 10A is a cross-sectional view in the sub-scanning direction at a location of the cam 310. FIG. 10B is a cross-sectional view in the sub-scanning direction at a location of the flag 307 and the photosensor 309. In this state, the state of the photosensor 309 is changed from the light-blocking state to the light-transmitting state by the flag 307. This allows the control board 302 to grasp the position of the glass moving portion 1c. The control board 302 can move the glass moving portion 1c to a desired position by inputting a signal of a predetermined number of pulses to the motor 308 from this position.

That is, in a case where the state of the photosensor 309 changes from the light-blocking state to the light-transmitting state, the control board 302 determines that the white reference plate 305 has started to move from the reading position of the reading unit 301 to the original position (home position). By being triggered when the state of the photosensor 309 changes from the light-blocking state to the light-transmitting state, the control board 302 moves the glass moving portion 1c from that position by a predetermined amount, to thereby move the white reference plate 305 to the home position. The reading unit 301 is also moved to a position for reading the sheet S in conjunction with the movement of the glass moving portion 1c.

FIG. 11 is a flow chart for illustrating reading processing for the sheet S to be performed by the reading unit 301. This processing is started in a case where the sheet S, on which an image has been formed by the recording portion 2300, is conveyed to the reading position of the reading unit 301 by the print belt unit 2200. The reading unit 301 is activated, for example, at the timing of start of a print job.

The control board 302 determines whether or not the image reading of the sheet S by the reading unit 301 has been started (Step S1101). The start of the image reading of the sheet S by the reading unit 301 is determined, for example, based on a change in the analog signal acquired from the light-receiving portion 404. In this case, for example, the print belt 25 is formed in black, and the color of the sheet S is set to a color (for example, white) other than black. When the image reading has not been started (Step S1101: N), the control board 302 stands by until the image reading by the reading unit 301 is started. When the image reading has been started (Step S1101: Y), the control board 302 drives the motor 308 in order to perform the shading correction (Step S1102).

As described with reference to FIG. 7A and FIG. 7B, the control board 302 determines whether or not the state of the photosensor 309 has changed from the light-transmitting state to the light-blocking state (Step S1103). When the state of the photosensor 309 remains the light-transmitting state (Step S1103: Y), the control board 302 stands by until the state of the photosensor 309 changes to the light-blocking state. When the state of the photosensor 309 has changed to the light-blocking state (Step S1103: Y), the control board 302 drives the motor 308 by a predetermined number of pulses (Step S1104). As a result, as described with reference to FIG. 8A and FIG. 8B, the inner box short shafts 303 ride up onto the upper side of the glass moving member 306, thereby raising the reading unit 301. This causes the reading distance of the reading unit 301 to become the distance (h2) matching the white reference plate 305 (Step S1105). In this state, the control board 302 executes the first sampling of the white reference plate 305 in order to perform the shading correction (Step S1106).

When the first sampling is ended, as described with reference to FIG. 9A and FIG. 9B, the control board 302 drives the motor 308 by a predetermined number of pulses (Step S1107), and executes the second sampling of the white reference plate 305 in order to perform the shading correction (Step S1108). The control board 302 generates shading correction data in which the influence of dust has been reduced based on sampling results (reading results) from the first sampling and the second sampling (Step S1109).

The control board 302, which has generated the shading correction data, resumes motor drive (Step S1110), and determines whether or not the state of the photosensor 309 has changed from the light-blocking state to the light-transmitting state as described with reference to FIG. 10A and FIG. 10B (Step S1111). When the state of the photosensor 309 remains the light-blocking state (Step S1111: N), the control board 302 stands by until the state of the photosensor 309 changes to the light-transmitting state. When the state has changed to the light-transmitting state (Step S1111: Y), the control board 302 drives the motor 308 by a predetermined number of pulses (Step S1112). As a result, as described with reference to FIG. 6A and FIG. 6B, the inner box short shafts 303 are positioned in the recesses in the upper side of the glass moving member 306, thereby lowering the reading unit 301. This causes the reading distance of the reading unit 301 to become the distance (h1) matching the sheet S (Step S1113).

In this state, the control board 302 causes the reading unit 301 to read the sheet S (Step S1114). When the sheet S is to be read, the shading correction data is used to correct operating conditions of the reading unit 301, such as the irradiation amount of the light sources 401a and 401b and the sensitivity variation of the photoelectric conversion elements of the light-receiving portion 404, or the reading result of the image on the sheet S. With this correction, the manufacturing variation and the variation in light amount are corrected.

Through the above-mentioned processing, the reading distance of the reading unit 301 varies in conjunction with the movement of the white reference plate 305 for performing the shading correction. For that reason, the reading distance is kept the same at the time of the shading correction and at the time of reading the sheet S, and it is thus possible to suppress deterioration in accuracy of the shading correction. As a result, the shading correction is performed with high accuracy, and hence the image on the sheet S is read with high accuracy. The deterioration in the image quality can thus be suppressed.

In the at least one embodiment, an example in which the image reading apparatus 1 is provided in the print module 2000 of the inkjet method has been described. The image reading apparatus 1 according to the at least one embodiment is also effective in a case where the image reading apparatus 1 is provided to other apparatus such as an in-line scanner of an electrophotographic image forming apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-158510, filed Sep. 22, 2023, which is hereby incorporated by reference herein in its entirety.

What is claimed is:

1. An image reading apparatus comprising:
a reading unit for reading an image formed on a sheet;
a reference member for performing shading correction; and
a moving mechanism comprising a drive source, a cam to be rotated by the drive source, and a moving member that abuts against the cam,
wherein, with a conveying direction of the sheet being a first direction, a width direction of the sheet intersecting the first direction being a second direction, and a direction intersecting the first direction and the second direction being a third direction, the moving mechanism is configured to be operable to move the reading unit to a first position and a second position that is different from the first position in position in the third direction, and
wherein the moving mechanism is configured to be moved by rotation of the cam, and the reading unit is moved by movement of the moving mechanism,
wherein the moving mechanism is configured to move the reading unit to the first position at a time of reading the sheet, and move the reading unit to the second position at a time of performing the shading correction, and
wherein the moving mechanism is configured to adjust a first distance in the third direction from the reading unit to the sheet and a second distance in the third direction from the reading unit to the reference member by moving the reading unit to the first position and the second position.

2. The image reading apparatus according to claim 1, wherein the moving mechanism is configured to move, at the time of performing the shading correction, the reference member to a reading position of the reading unit.

3. The image reading apparatus according to claim 2, wherein the moving mechanism is configured to perform, at the time of performing the shading correction, movement of the reference member and movement of the reading unit in conjunction with each other.

4. The image reading apparatus according to claim 3,
wherein the reference member is attached to the moving member, and
wherein the moving member is configured to move the reference member by having the moving member moved by the rotation of the cam.

5. The image reading apparatus according to claim 1, wherein the moving mechanism is configured to perform, at the time of performing the shading correction, the adjustment so as to control the first distance and the second distance to become the same.

6. The image reading apparatus according to claim 1,
wherein the reading unit is configured to read the sheet being conveyed by being attracted onto a predetermined surface, and
wherein the moving mechanism is configured to move, at the time of performing the shading correction, the reference member in the first direction, and move the reading unit in the third direction.

7. The image reading apparatus according to claim 6, wherein the moving mechanism is configured to move, in a case where the reading of the reference member by the reading unit is ended, the reference member in a direction opposite to the first direction, and move the reading unit in a direction opposite to the third direction.

8. The image reading apparatus according to claim 6, wherein the moving mechanism is configured to control the reading unit to read two positions on the reference member that differ from each other in the first direction.

9. An image forming apparatus comprising:
an image forming unit configured to form an image on a sheet;
a reading unit for reading the image formed on the sheet by the image forming unit;
a reference member for performing shading correction; and
a moving mechanism comprising a drive source, a cam to be rotated by the drive source, and a moving member that abuts against the cam,
wherein, with a conveying direction of the sheet being a first direction, a width direction of the sheet intersecting the first direction being a second direction, and a direction intersecting the first direction and the second direction being a third direction, the moving mechanism is configured to be operable to move the reading unit to a first position and a second position that is different from the first position in position in the third direction, and
wherein the moving mechanism is configured to be moved by rotation of the cam, and the reading unit is moved by movement of the moving mechanism,
wherein the moving mechanism is configured to move the reading unit to the first position at a time of reading the sheet, and move the reading unit to the second position at a time of performing the shading correction, and
wherein the moving mechanism is configured to adjust a first distance in the third direction from the reading unit to the sheet and a second distance in the third direction from the reading unit to the reference member by moving the reading unit to the first position and the second position.

10. The image forming apparatus according to claim 9, wherein the image forming unit is configured to correct the image to be formed on the sheet based on a reading result of the image obtained by the reading unit.

11. The image forming apparatus according to claim 9, further comprising a control unit configured to generate shading correction data based on a reading result of the reference member obtained by the reading unit,
wherein the control unit is configured to correct, based on the shading correction data, an operating condition of the reading unit at a time of reading the sheet.

12. The image forming apparatus according to claim 9, further comprising a control unit configured to generate shading correction data based on a reading result of the reference member obtained by the reading unit,
wherein the control unit is configured to correct, based on the shading correction data, a reading result of the sheet obtained by the reading unit.
